(19) United States
(12) Patent Application Publication
(10) Pub. No.: US 2007/0115586 A1
(43) Pub. Date: May 24, 2007

(54) Method of manufacturing magnetic recording medium, magnetic recording medium stamper, and magnetic recording medium preform

(76) Inventors: Mitsuru Takai, Tokyo (JP); Kazuhiro Hattori, Tokyo (JP)

Correspondence Address: GREENBLUM & BERNSTEIN, P.L.C., 1950 ROLAND CLARKE PLACE, RESTON, VA, 20191, US

(21) Appl. No.: 10/565,125

(22) PCT Filed: Jul. 20, 2004
(86) PCT No.: PCT/JP04/10299

§ 371 Date: Jan. 19, 2006

(30) Foreign Application Priority Data
Jul. 22, 2003 (JP) 2003-199730

(51) Int. Cl. G11B 5/82

(52) U.S. Cl. 360/131; 360/135

(57) ABSTRACT

There is provided a method of manufacturing a magnetic recording medium with improved manufacturing efficiency.

A discrete track magnetic recording medium is manufactured as follows. A resist layer 58a is formed on a preform M in the form of a flat plate where a recording layer 55 is formed on a glass substrate 51 and a preform center of the preform M is specified. The stamper S is placed on the preform M with the specified preform center and the stamper center specified based on a stamper center specifying mark Sm formed on the stamper S aligned when viewed from the thickness direction of the preform M to transfer a concave/convex pattern of the stamper S to the resist layer 58a. The resist layer 58a to which the concave/convex pattern has been transferred is used to form concave parts in the recording layer 55 of the preform M.

### TECHNICAL FIELD

The present invention relates to a method of manufacturing a magnetic recording medium that manufactures a discrete track magnetic recording medium by placing a magnetic recording medium stamper on a magnetic recording medium preform on which a resin layer is formed to transfer a concave/convex pattern to the resin layer and thereby form concave parts in a magnetic layer of a magnetic recording medium preform using the resin layer, and also to a magnetic recording medium stamper, and magnetic recording medium preform.

### BACKGROUND ART

As a method of manufacturing this type of discrete track magnetic recording medium (hereinafter simply “discrete track medium”), in Japanese Laid-Open Patent Publication No. 2003-9625 the present applicant discloses a method of manufacturing that forms a mask by pressing a mold (24: “stamper”) onto a resist layer (R) formed on a disk-shaped substrate (D) using a transfer device (2) and then uses the mask to manufacture a discrete track medium. Note that in the present specification, reference numerals relating to this prior application are written in parentheses. In more detail, first a resist layer (R) is formed on a disk-shaped substrate (D) by spin coating a resist material. Next, after the disk-shaped substrate (D) has been fixed to a heating stage (21) and a mold (24) has been fixed to a press mechanism (22), the heating stage (21) and the press mechanism (22) are controlled to heat the disk-shaped substrate (D) and the mold (24). Next, the press mechanism (22) presses the mold (24) toward the disk-shaped substrate (D). At this time, convex parts (24p) of the mold (24) are pressed into the resist layer (R) on the disk-shaped substrate (D) resulting in the resist material entering concave parts of the mold (24). Next, heating by the heating stage (21) and the press mechanism (22) are stopped and after the temperature of the resin layer (R) and the mold (24) has fallen to a predetermined temperature, the press mechanism (22) withdraws the mold (24) from the resin layer (R). By doing so, the concave/convex pattern of the mold (24) is transferred to the resist layer (R), resulting in the resist pattern (mask) being formed in the disk-shaped substrate (D).

Next, by carrying out an oxygen plasma process on the entire resist pattern on the disk-shaped substrate (D), a magnetic layer (F) of the disk-shaped substrate (D) is exposed from base surfaces of the concave parts in the resist pattern. Next, a metal layer (M) is formed by depositing metal on front end surfaces of the convex parts in the resist pattern and the parts of the surface of the magnetic layer (F) that are exposed at the base surfaces of the concave parts in the resist pattern (i.e., the base surfaces of the concave parts). Next, the metal layer (M) formed on the front ends of the convex parts of the resist pattern is removed together with the resist material by a lift off process. By doing so, a metal pattern is formed where only the metal layer (M) formed on the surface of the magnetic layer (F) remains on the disk-shaped substrate (D). Next, a reactive ion etching process is carried out on the magnetic layer (F) using the metal pattern as a mask. By doing so, the magnetic layer (F) is removed at positions that are not covered by the mask to form a plurality of concentric grooves in the magnetic layer (F). Next, by carrying out reactive ion etching, the metal pattern remaining on the magnetic layer (F) is removed. After this, by carrying out a surface finishing process and the like, a plurality of data recording tracks (discrete tracks: hereinafter simply “tracks”) for recording data are concentrically formed to manufacture a discrete track medium.

Prior Application 1:

Japanese Patent Application No. 2003-009625

### DISCLOSURE OF THE INVENTION

### Problem to be Solved by the Invention

By investigating the method of manufacturing a discrete track medium proposed by the present applicant, the present inventors discovered the following problem to be solved. That is, according to the method of manufacturing proposed by the present applicant, in a state where the disk-shaped substrate (D) is fixed to the heating stage (21) and the mold (24) is fixed to the press mechanism (22), the press mechanism (22) moves the mold (24) toward the disk-shaped substrate (D) and presses the convex parts (24p) into the resist layer (R) to transfer the concave/convex pattern. In this case, on a discrete track medium manufactured in accordance with this type of method of manufacturing, as described above, the tracks for recording data are formed when manufacturing the medium. For this reason, to make it possible to carry out tracking correctly and easily for the respective tracks during the recording and reproduction of data, it is necessary to form grooves in the magnetic layer (F) so that the center of each track matches the center of rotation (that is, the center of the discrete track medium) of the discrete track medium during the recording and reproduction of data. Accordingly, the resist pattern (mask) used to form grooves in the magnetic layer (F) of the disk-shaped substrate (D) needs to be formed without being eccentric with respect to the center of the disk-shaped substrate (D). For this reason, when forming the resist pattern, it is necessary to press the mold (24) into the resist layer (R) on the disk-shaped substrate (D) in a state where the center of the disk-shaped substrate (D) and the center of the mold (24) (more specifically, the center of the concave/convex pattern of the mold (24)) are aligned when viewed from the thickness direction of the disk-shaped substrate (D).

In this case, the applicant fixes the disk-shaped substrate (D) in a state where the center of the disk-shaped substrate (D) is aligned to a reference point on the heating stage (21) and fixes the mold (24) in a state where the center of the mold (24) is aligned to a reference point on the press mechanism (22), and transfers the concave/convex pattern by moving the mold (24) toward the disk-shaped substrate (D) with the reference points of both the heating stage (21) and the press mechanism (22) aligned when viewed from the thickness direction of the disk-shaped substrate (D), thereby preventing the resist pattern (mask) from becoming eccentric with respect to the center of the disk-shaped substrate (D) (eccentricity of the disk-shaped substrate (D) to whose resist layer (R) the concave/convex pattern is transferred). When doing so, it is necessary to specify the center of the disk-shaped substrate (D), for example, by measuring the coordinates of three arbitrary points on the outer edge of the disk-shaped substrate (D) using an industrial microscope or the like and calculating the center of the disk-shaped substrate (D) based on such measurement results. It is also necessary to specify the center of the mold (24), for example, by measuring the coordinates of three points on an arbitrary convex part (24p) in the concave/convex pattern of the mold (24) and calculating the center of the mold (24) based on such measurement results. Since the measurement process and calculation process are complex, in the method of manufacturing proposed by the applicant, there is the problem that it is difficult to improve the manufacturing efficiency of discrete track media.

The present invention was conceived to solve the problem described above, and it is a principal object of the present invention to provide a method of manufacturing a magnetic recording medium, a magnetic recording medium stamper, and a magnetic recording medium preform that can improve the manufacturing efficiency of discrete track media.

### MEANS FOR SOLVING THE PROBLEMS

A method of manufacturing a magnetic recording medium according to the present invention manufactures a discrete track magnetic recording medium and includes: forming a resin layer on a magnetic recording medium preform in the shape of a flat plate where a magnetic layer is formed on a support substrate and specifying a preform center of the magnetic recording medium preform; placing a magnetic recording medium stamper on the magnetic recording medium preform with the specified preform center and a stamper center specified based on a stamper center specifying mark formed on the magnetic recording medium stamper aligned when viewed from the thickness direction of the magnetic recording medium preform to transfer a concave/convex pattern of the magnetic recording medium stamper to the resin layer; and forming concave parts in the magnetic layer of the magnetic recording medium preform using the resin layer to which the concave/convex pattern has been transferred. Note that the discrete track magnetic recording medium for the present invention is not limited to a magnetic recording medium including a data recording region where adjacent data recording tracks (magnetic parts) are magnetically isolated by a plurality of grooves formed concentrically or a groove formed in a spiral, and also includes a so-called “patterned medium” where data recording parts (magnetic parts), which are formed by partitioning (each data recording track is magnetically partitioned into a plurality of sections in the lengthwise direction thereof) the data recording region in a mesh or into dots, are isolated as “islands”.

In this case, it is preferable to use a magnetic recording medium preform on which a preform center specifying mark that can specify the preform center is formed as the magnetic recording medium preform and to transfer the concave/convex pattern to the resin layer by placing the magnetic recording medium stamper on the magnetic recording medium preform with the preform center, which is specified based on the preform center specifying mark, and the stamper center aligned when viewed from the thickness direction.

A magnetic recording medium stamper according to the present invention has a concave/convex pattern for manufacturing a discrete track magnetic recording medium formed thereon and a stamper center specifying mark capable of specifying a center of the stamper formed thereon.

In this case, the stamper center specifying mark is preferably constructed of one of a convex part where part of a central area of the magnetic recording medium stamper protrudes and a concave part where part of a central area of the magnetic recording medium stamper is depressed.

Also, a magnetic recording medium preform according to the present invention has a magnetic layer formed on a support substrate so as to be capable of manufacturing a discrete track magnetic recording medium and a preform center specifying mark capable of specifying a center of the magnetic recording medium preform is formed thereon.

In this case, the preform center specifying mark is preferably constructed of one of a convex part where part of a central area of the magnetic recording medium preform protrudes and a concave part where part of a central area of the magnetic recording medium preform is depressed.

### EFFECT OF THE INVENTION

According to the method of manufacturing a magnetic recording medium according to the present invention, a magnetic recording medium stamper is placed on a magnetic recording medium preform with a stamper center specified based on a stamper center specifying mark formed on the magnetic recording medium stamper and a preform center of the magnetic recording medium preform aligned when viewed from the thickness direction of the magnetic recording medium preform to transfer a concave/convex pattern of the magnetic recording medium stamper to a resin layer, and therefore compared for example to a method that specifies the stamper center by calculation after measuring the coordinates of three points on an arbitrary convex part in the concave/convex pattern of the magnetic recording medium stamper, it is possible to reliably and easily specify the stamper center in a short time. Accordingly, since it is possible to position the magnetic recording medium stamper relative to a magnetic recording medium manufacturing apparatus (imprinting device) in a short time, the manufacturing efficiency of a discrete track medium can be sufficiently improved.

Also, according to the method of manufacturing a magnetic recording medium according to the present invention, by specifying the preform center based on a preform center specifying mark, compared for example to a method that specifies the preform center by calculation after measuring coordinates of three arbitrary points on the outer edge of the magnetic recording medium preform, it is possible to reliably and easily specify the preform center in a short time. Accordingly, since it is possible to position the magnetic recording medium preform on a magnetic recording medium manufacturing apparatus (imprinting device) in a short time, the manufacturing efficiency of a discrete track medium can be significantly improved.

In addition, according to the magnetic recording medium stamper according to the present invention, by constructing the magnetic recording medium stamper by forming the stamper center specifying mark that can specify the stamper center, compared for example to a method that specifies the stamper center by calculation after measuring the coordinates of three points on an arbitrary convex part in the concave/convex pattern of the magnetic recording medium stamper, it is possible to reliably and easily specify the stamper center in a short time. Accordingly, since it is possible to position the magnetic recording medium stamper relative to a magnetic recording medium manufacturing apparatus (imprinting device) in a short time, the manufacturing efficiency of a discrete track medium can be sufficiently improved.

Also, according to the magnetic recording medium stamper according to the present invention, by constructing the stamper center specifying mark of one of a convex part where part of a central area of the magnetic recording medium stamper protrudes and a concave part where part of a central area of the magnetic recording medium stamper is depressed, it is possible to reliably recognize the position of the stamper center specifying mark.

Also according to the magnetic recording medium preform according to the present invention, by constructing the magnetic recording medium preform by forming a preform center specifying mark capable of specifying the preform center, compared for example to a method that specifies the preform center by calculation after measuring coordinates of three arbitrary points on the outer edge of the magnetic recording medium preform, it is possible to reliably and easily specify the preform center in a short time. Accordingly, since it is possible to position the magnetic recording medium preform on a magnetic recording medium manufacturing apparatus (imprinting device) in a short time, the manufacturing efficiency of a discrete track medium can be significantly improved.

Also, according to the magnetic recording medium preform according to the present invention, by constructing the preform center specifying mark of one of a convex part where part of a central area of the magnetic recording medium preform protrudes and a concave part where part of a central area of the magnetic recording medium preform is depressed, it is possible to reliably recognize the position of the preform center specifying mark.

### BEST MODE FOR CARRYING OUT THE INVENTION

Preferred embodiments of a method of manufacturing a magnetic recording medium, a magnetic recording medium stamper, and a magnetic recording medium preform according to the present invention will now be described with reference to the attached drawings. Note that for ease of understanding the present invention, in the drawings referred to by this description, the ratios of the thicknesses of respective layers, the widths, heights, and depths of convex parts and concave parts, and the like are illustrated using ratios, widths, heights, and depths that differ to those actually used.

First, the construction of a magnetic recording medium manufacturing apparatus 1 that manufactures a discrete track magnetic recording medium (hereinafter simply “discrete track medium”) according to the method of manufacturing a magnetic recording medium according to the present invention will be described with reference to the drawings.

As shown in FIG. 1, the magnetic recording medium manufacturing apparatus 1 is constructed so as to be capable of manufacturing a discrete track medium D using a magnetic recording medium preform (hereinafter simply “preform”) M manufactured by a preform manufacturing apparatus 2 and a magnetic recording medium stamper (hereinafter simply “stamper”) S manufactured by a stamper manufacturing apparatus 3, and includes an applying device 11, an imprinting device 12, and an etching device 13. In this case, the discrete track medium D is a magnetic recording medium for perpendicular magnetic recording, and as shown in FIG. 2, a base layer 52, a soft magnetic layer 53, an oriented layer 54, a recording layer 55 (a “magnetic layer” for the present invention), and a protective layer 56 are laminated in that order on a glass substrate 51 (a “support substrate” for the present invention) with a diameter of around 21.6 mm. Also, on the discrete track medium D, a plurality of grooves F, F . . . with a depth that reaches the oriented layer 54 are concentrically formed, thereby concentrically forming a plurality of discrete tracks (hereinafter simply “tracks”) T, T . . . for recording data.

As shown in FIG. 3, the preform M is constructed by laminating the base layer 52, the soft magnetic layer 53, the oriented layer 54, the recording layer 55, and protective layers 56, 57 on the glass substrate 51 in that order, and as shown in FIG. 4, the preform M has an overall disk-like shape. A mark Mm that corresponds to a “preform center specifying mark” for the present invention is formed in the center of the preform M. In this case, as shown in FIG. 3, the mark Mm is constructed of a circular concave part with a diameter of around 99.8 μm and a depth of around 29.9 μm formed by making part of a central area of the preform M concave. As shown in FIG. 5, the stamper S is formed by laminating a conductive film 63 and a metal film 64, and as shown in FIG. 6, the stamper S has an overall disk-like shape. A concentric concave/convex pattern (as one example, a concave/convex pattern with a formation pitch of around 150 nm) for forming a mask 58 on the preform M described later is formed on the surface of the stamper S and a mark Sm corresponding to a “stamper center specifying mark” for the present invention is formed in a center of the stamper S. In this case, as shown in FIG. 5, the mark Sm is constructed of a circular concave part with a diameter of around 90 μm and a depth of around 0.2 μm formed by depressing part of a central area of the stamper S.

On the other hand, the applying device 11 forms a resist layer 58a (one example of a “resin layer” for the present invention: see FIG. 18) by spin coating the preform M with a resist. As shown in FIG. 1, the imprinting device 12 includes a press base section 12a constructed in the same way as the heating stage of the transfer device (2) proposed by the applicant and a press head section 12b constructed in the same way as the press mechanism of the transfer device (2). The imprinting device 12 presses the stamper S into the resist layer 58a formed by the applying device 11 to transfer the concave/convex pattern of the stamper S to the resist layer 58a and thereby form the mask 58 (see FIG. 21) on the preform M. The etching device 13 etches the preform M using the mask formed by the imprinting device 12 to form grooves F, F . . . in the preform M, thereby manufacturing the discrete track medium D. Note that in reality, the etching device 13 includes an etching device that carries out dry etching with plasma using oxygen gas or ozone gas, an etching device that carries out reactive ion etching with CF₄ gas or SF₆ gas as the reactive gas, an etching device that carries out reactive ion etching with CO gas to which NH₃ gas has been added as the reactive gas, and an etching device that carries out reactive ion etching with SF₆ gas as the reactive gas.

Next, the construction of the preform manufacturing apparatus 2 and the method of manufacturing the preform M using the preform manufacturing apparatus 2 will be described with reference to the drawings.

As shown in FIG. 7, the preform manufacturing apparatus 2 includes an injection molding device 21, a grinding device 22, and laminating devices 23 to 25. The injection molding device 21 molds a disk-shaped glass substrate 51a (see FIG. 8). The grinding device 22 grinds the front and rear surfaces of the glass substrate 51a molded by the injection molding device 21 to fabricate the glass substrate 51. The laminating device 23 laminates the base layer 52, the soft magnetic layer 53, the oriented layer 54, and the recording layer 55 in that order on the glass substrate 51 by sputtering, for example. The laminating device 24 laminates the protective layer 56 on the recording layer 55 by CVD, for example. The laminating device 25 manufactures the preform M by laminating the protective layer 57 on the protective layer 56 by sputtering, for example.

When manufacturing the preform M using the preform manufacturing apparatus 2, first the disk-shaped glass substrate 51a is molded with a thickness of around 0.50 mm by the injection molding device 21. When doing so, as shown in FIG. 8, a circular concave part 51m with a diameter of around 100 μm and a depth of around 150 μm is formed in the center of the glass substrate 51a. The glass substrate 51a molded by the injection molding device 21 has extremely small convexes and concaves on a surface thereof (that is, the surface is slightly rough). Next, the grinding device 22 grinds the surface of the glass substrate 51a by around 0.12 mm until the position of the broken line in FIG. 8 is reached to manufacture the glass substrate 51 that is around 0.38 mm thick. At this time, as a result of the surface of the glass substrate 51a being ground using the grinding device 22, the depth of the circular concave part 51m becomes around 30 μm. Next, as shown in FIG. 9, the laminating device 23 laminates the base layer 52, the soft magnetic layer 53, the oriented layer 54, and the recording layer 55 in that order on the surface (the surface on which the circular concave part 51m is formed) of the glass substrate 51. At this time, the laminating device 23 sputters Cr (chromium) or Cr alloy on the glass substrate 51 to form the base layer 52 with a thickness of around 10 nm to 200 nm. The laminating device 23 also sputters Fe (iron) or Co (cobalt) on the base layer 52 to form the soft magnetic layer 53 with a thickness of around 50 nm to 300 nm. Also, the laminating device 23 sputters one of CoO, MgO, and NiO on the soft magnetic layer 53 to form the oriented layer 54 with a thickness of around 3 nm to 30 nm. Also, the laminating device 23 sputters Co or a Co alloy including CoCrPt (cobalt-chromium-platinum) on the oriented layer 54 to form the recording layer 55 with a thickness of around 10 nm to 30 nm. In this case, the materials for forming the soft magnetic layer 53, the oriented layer 54, and the recording layer 55 are not limited to the example materials mentioned above, and various materials can be selected as appropriate.

In this case, since the circular concave part 51m is formed in the center of the glass substrate 51, when the various layers are laminated in order on the glass substrate 51 by the laminating device 23, parts that overlap the circular concave part 51m when viewed from the thickness direction of the glass substrate 51 are depressed so that a circular concave part 55m with a diameter of around 99.8 μm and a depth of around 29.9 μm is formed in the recording layer 55. Next, as shown in FIG. 10, the laminating device 24 deposits diamond-like carbon (a material with an amorphous structure that has carbon as a main constituent and a measured value (hardness) of around 200 to 8000 kgf/mm² in a Vickers hardness test) by CVD on the recording layer 55, to form the protective layer 56 with a thickness of 1 to 5 nm. At this time, since the circular concave part 55m is formed on the recording layer 55, when the protective layer 56 is formed on the recording layer 55 by the laminating device 24, a part that overlaps the circular concave part 55m when viewed from the thickness direction of the glass substrate 51 is depressed so that a circular concave part 56m with a diameter of around 99.8 μm and a depth of around 29.9 μm is formed in the protective layer 56. Next, the laminating device 25 sputters TiN (titanium nitride) on the protective layer 56 so that as shown in FIG. 3, the protective layer 57 that is around 10 to 50 nm thick is formed. At this time, since the circular concave part 56m is formed in the protective layer 56, when the protective layer 57 is formed on the protective layer 56 by the laminating device 25, a part that overlaps the circular concave part 56m when viewed from the thickness direction of the glass substrate 51 is depressed so that a circular concave part (the mark Mm) is formed with a diameter of around 99.8 μm and a depth of around 29.9 μm is formed in the protective layer 57. By doing so, the preform M is completed as shown in FIG. 3.

Next, the construction of the stamper manufacturing apparatus 3 and the method of manufacturing that manufactures the stamper S using the stamper manufacturing apparatus 3 will be described with reference to the drawings.

As shown in FIG. 11, the stamper manufacturing apparatus 3 includes an applying device 31, a drawing device 32, a developing device 33, an etching device 34, a laminating device 35 and an electroforming device 36. The applying device 31 applies a resist by spin coating, for example, on a glass substrate 61 whose surface has been made conductive, thereby forming a resist layer 62a (see FIG. 12). The drawing device 32 irradiates the resist layer 62a formed by the applying device 31 with an electron beam EB to form a latent image 62b (see FIG. 12). The developing device 33 develops the resist layer 62a for which the formation of the latent image 62b by the drawing device 32 has been completed, thereby forming a mask 62 on the glass substrate 61 (see FIG. 13). The etching device 34 uses the mask 62 formed by the developing device 33 to form concave parts 61a, 61a . . . on the glass substrate 61 (see FIG. 14). The laminating device 35 forms the conductive film 63 by covering the glass substrate 61 in which the concave parts 61a have been formed (see FIG. 15). The electroforming device 36 carries out an electroplating process to form the metal film 64 on the conductive film 63 (see FIG. 16).

When the stamper S is manufactured by the stamper manufacturing apparatus 3, first, as shown in FIG. 12, the applying device 31 applies the resist (as one example, the positive-type resist “ZEP520A” made by ZEON CORPORATION of Japan) onto the glass substrate 61 by spin coating to form the resist layer 62a with a thickness of around 200 nm, for example. Next, after the resist layer 62a has been hardened by carrying out a baking process at 180° C. for around five minutes, for example, the glass substrate 61 in this state is set on the drawing device 32. Next, the drawing device 32 irradiates parts in the concave/convex pattern of the stamper S where convex parts are formed with an electron beam EB used for patterning. By doing so, the concentric latent images 62b, 62b . . . are formed in the resist layer 62a. Next, by developing the resist layer 62a in this state, the developing device 33 removes parts of the latent image 62b to expose part of the surface of the glass substrate 61 as shown in FIG. 13. At this time, as one example, the product “ZED-N50” (made by ZEON CORPORATION of Japan) is used as the developer, with the substrate being soaked for three minutes with the developer at 26° C., for example. By doing so, the mask 62 (resist pattern) is formed on the glass substrate 61. In this case, in the stamper manufacturing apparatus 3, when the mask 62 is formed by the drawing device 32 and the developing device 33, as one example a cylindrical convex part 62m with a diameter of around 90 μm and a depth of 0.2 μm is formed in the center of the glass substrate 61. Next, after the glass substrate 61 in this state has been soaked in a rinse (as one example, the product “ZMD-D” (made by ZEON CORPORATION of Japan)) at 23° C. (room temperature) for example, nitrogen gas is blown onto the mask 62 to dry the mask 62.

Next, as shown in FIG. 14, the etching device 34 etches the glass substrate 61 using the mask 62. When doing so, the parts of the glass substrate 61 not covered by the mask 62 are etched to form concave parts in the surface of the glass substrate 61 and as a result, concentric concave parts 61a, 61a . . . with a depth of around 200 nm and a width of around 100 nm are formed in the glass substrate 61. In addition, a cylindrical convex part 61m with a height of around 0.2 μm and a diameter of around 90 μm is formed at a position in the center of the glass substrate 61 that is covered by the convex part 62m of the mask 62. Next, by soaking the glass substrate 61 in this state in a resist remover, the mask 62 remaining on the glass substrate 61 is removed. After this, as shown in FIG. 15, the laminating device 35 deposits Ni (nickel) on the surface (the surface in which the concave parts 61a, 61a . . . are formed) of the glass substrate 61 to form the conductive film 63 with a thickness of around 30 nm. Next, as shown in FIG. 16, the electroforming device 36 carries out an electroplating process (a depositing process) using the conductive film 63 as an electrode to form the metal film (electro nickel film) 64 with a thickness of around 300 μm on the conductive film 63. Next, as shown in FIG. 17, by removing the multilayer structure of the conductive film 63 and the metal film 64 from the glass substrate 61, the stamper S is completed, as shown in FIG. 5. In this case, since the cylindrical convex part 61m is formed in the center of the glass substrate 61, a circular concave part (the mark Sm) with a diameter of around 90 μm and a depth of around 0.2 μm is formed in a central area of the completed stamper S.

Next, a method of manufacturing the discrete track medium D with the magnetic recording medium manufacturing apparatus 1 using the preform M and the stamper S will be described with reference to the drawings.

First, as shown in FIG. 18, the applying device 11 spin coats the resist (as one example, the negative-type resist “NEB22A” made by SUMITOMO CHEMICAL CO., Ltd.) onto the preform M to form a resist layer 58a with a thickness of around 100 nm. When doing so, since the mark Mm (circular concave part) with a diameter of around 99.8 μm and a depth of around 29.9 μm is formed in the preform M (the protective layer 57) when the resist layer 58a is formed on the preform M by the applying device 11, the part that overlaps the mark Mm when viewed from the thickness direction of the glass substrate 51 is depressed so that a circular concave part 58m is formed in the resist layer 58a with a diameter of around 99.6 μm and a depth of around 29.8 μm. Next, the resist layer 58a is hardened by carrying out a baking process at a temperature of 180° C. for around five minutes, for example.

Next, the preform M for which the resist layer 58a has completely hardened is set on the press base section 12a of the imprinting device 12. In this case, first by observing the surface of the preform M (the resist layer 58a) using an industrial microscope, for example, the center of the preform M is specified. In this case, since the circular concave part 58m is formed in the surface of the resist layer 58a, it is possible to specify the center of the preform M based on the position of the circular concave part 58m (that is, the position of the mark Mm of the preform M). Accordingly, compared to a method of calculating the center by finding the coordinates of three arbitrary points on the outer edge of the preform M using an industrial microscope, the center of the preform M can be specified in around one fifth of the time. Next, as shown in FIG. 19, after the position of the preform M has been finely adjusted to align the specified center with a reference position P1 of the press base section 12a when viewed from the thickness direction of the preform M, the preform M is fixed to the press base section 12a. By doing so, the setting of the preform M is completed.

Next, the stamper S is set on the press head section 12b of the imprinting device 12 with the surface on which the concave/convex pattern has been formed facing downward. When doing so, first, by observing the surface of the stamper S using an industrial microscope, for example, the center of the stamper S is specified. In this case, since the mark Sm is formed in the center of the stamper S, it is possible to specify the center of the stamper S based on the position of the mark Sm. Accordingly, compared to a method of calculating the center by finding the coordinates of three points on an arbitrary convex part in the concave/convex pattern on the stamper S using an industrial microscope, the center of the stamper S can be specified in around one fifth of the time. Next, after the position of the stamper S has been finely adjusted to align the specified center with a reference position P2 of the press head section 12b when viewed from the thickness direction of the stamper S, the stamper S is fixed to the press head section 12b. By doing so, the setting of the stamper S is completed.

Next, the preform M (the resist layer 58a) and the stamper S are heated by the imprinting device 12. At this time, the resist layer 58a on the preform M is heated by the press base section 12a to a temperature (as one example, around 170° C.) that is equal to or greater than the glass transition point. Next, the press head section 12b moves the stamper S toward the preform M (the resist layer 58a) on the press base section 12a and as shown in FIG. 20, presses the convex parts in the concave/convex pattern of the stamper S into the resist layer 58a. At this time, the imprinting device 12 moves the stamper S toward the preform M so that the reference position P2 of the press head section 12b matches the reference position P1 of the press base section 12a when viewed from the thickness direction of the preform M. As a result, the mark Mm of the preform M and the mark Sm of the stamper S are aligned when viewed from the thickness direction of the preform M. The imprinting device 12 presses the stamper S with a pressure of 170 kg/cm², for example. As a result, the resist (the resist layer 58a) that has been heated to the glass transition point enters the concave parts in the concave/convex pattern of the stamper S. Next, the heating of the preform M and the stamper S by the press base section 12a and the press head section 12b is stopped and after the temperature of the resist layer 58a and the like has fallen to a predetermined temperature (as one example, around 50° C.) the press head section 12b withdraws the stamper S from the resist layer 58a. By doing so, as shown in FIG. 21, the concave/convex pattern of the stamper S is transferred to the resist layer 58a to form the mask 58 on the preform M.

Next, the etching device 13 carries out dry etching uniformly on the entire mask 58 on the preform M with plasma produced using oxygen gas or ozone gas. At this time, the resist on the base surfaces of the concave parts in the concave/convex pattern of the mask 58 is removed to expose the protective layer 57 from the mask 58. Next, the etching device 13 etches the protective layer 57 exposed from the mask 58 by reactive ion etching with CF₄ gas or SF₆ gas as the reactive gas. When doing so, as shown in FIG. 22, the protective layer 56 and parts of the recording layer 55 are etched together with the protective layer 57 to form the grooves F, F . . . with a depth that reaches the recording layer 55. Also when doing so, the majority of the mask 58 is removed. Next, the etching device 13 etches the recording layer 55 by reactive ion etching with CO gas to which NH₃ gas has been added as the reactive gas to form grooves F, F . . . with a depth that reaches the oriented layer 54. After doing so, the etching device 13 carries out reactive ion etching with SF₆ gas as the reactive gas to remove the protective layer 57 remaining on the protective layer 56. By doing so, as shown in FIG. 2, the discrete track medium D is completed.

In this way, according to the method of manufacturing a discrete track medium D, alignment is carried out so that the center of the stamper S specified based on the mark Sm formed on the stamper S and the center of the preform M match when viewed from the thickness direction of the preform M and then the concave/convex pattern of the stamper S is transferred to the resist layer 58a, so that compared for example to a method that specifies the center of the stamper S by calculation after measuring the coordinates of three points on an arbitrary convex part in the concave/convex pattern of the stamper S, it is possible to reliably and easily specify the center of the stamper S in a short time. Accordingly, since it is possible to position the stamper S relative to the imprinting device 12 in a short time, the manufacturing efficiency of the discrete track medium D can be sufficiently improved.

In addition, according to the method of manufacturing the discrete track medium D, by specifying the center of the preform M based on the mark Mm, compared for example to a method that specifies the center of the preform M by calculation after measuring coordinates of three arbitrary points on the outer edge of the preform M, it is possible to reliably and easily specify the center of the preform M in a short time. Accordingly, since it is possible to position the preform M on the imprinting device 12 in a short time, the manufacturing efficiency of the discrete track medium D can be significantly improved.

In this case, according to the stamper S according to the present embodiment, by including the mark Sm that is a circular concave part where part of a central area of the stamper S is depressed, it is possible to reliably identify the position of the mark Sm.

In addition, according to the preform M according to the present embodiment, by including the mark Mm that is a circular concave part where part of a central area of the preform M is depressed, it is possible to reliably identify the position of the mark Mm.

It should be noted that the present invention is not limited to the embodiment described above and can be modified as appropriate. For example, although an example where the mark Mm of the preform M and the mark Sm of the stamper S are respectively composed of circular concave parts has been described for the above embodiment of the present invention, the present invention is not limited to this. For example, in the same way as a preform Mx shown in FIG. 23, to make it possible to specify the center of the preform Mx during the manufacturing of the discrete track medium D, it is possible to use a construction where a cylindrical (convex) mark Mmx is formed in the center of the preform Mx. By laminating the base layer 52, the soft magnetic layer 53, the oriented layer 54, the recording layer 55, and the protective layers 56, 57 in that order on a glass substrate 51x in whose center a convex part 51mx with a height of around 0.2 μm is formed, the mark Mmx can be formed so as to protrude at a position that overlaps the concave part 51mx when viewed from the thickness direction of the glass substrate 51x. In the same way, like a stamper Sx shown in FIG. 24, for example, it is possible to use a construction where a cylindrical (convex) mark Smx is formed in the center of the stamper Sx to make it possible to specify the center of the stamper Sx during the manufacturing of the discrete track medium D.

In addition, although an example of a preform M including a mark Mm constructed of a circular concave part and a stamper S including a mark Sm constructed of a circular concave part has been described for the above embodiment of the present invention, the shapes of the preform center specifying mark and the stamper center specifying mark for the present invention are not limited to this and in the same way as the marks Mm1, Sm1 shown in FIG. 25, for example, it is possible to form part of the central area of the preform M (and/or the stamper S) so as to protrude (or be depressed) in the shape of a plus sign. Also, so long as the preform center specifying mark and the stamper center specifying mark for the present invention can specify the center of the preform M and the center of the stamper S, the marks themselves do not need to be present at the actual centers. More specifically, as shown in FIG. 26, it is possible to use a construction that specifies the center positions using marks Mm2, Sm2 where intersecting parts (parts corresponding to the center of the preform and the center of the stamper) of the marks Mm1, Sm1 described above for example are not present. In addition, the preform center specifying mark and stamper center specifying mark for the present invention are not limited to marks formed so that a part of a central area of the preform M (the stamper S) protrudes (or is depressed) and for example it is possible to use a construction where the preform center specifying mark is formed by modifying part of the protective layer 57 so as to be distinguishable (identifiable) with respect to the periphery thereof.

Also, the diameter and depth of the mark Mm and the mark Sm described above in the embodiment of the present invention are mere examples, and the present invention is not limited to such values. In addition, although an example where the discrete track medium D is manufactured using the preform M that uses the disk-shaped glass substrate 51 as a support substrate is described above in the embodiment of the present invention, the present invention is not limited to this and it is possible to manufacture the discrete track medium D using a preform M that uses various kinds of support substrate such as a ceramic substrate and a metal substrate. Also, although an example of a method of manufacturing that manufactures the stamper S using the glass substrate 61 as a support substrate has been described in the above embodiment of the present invention, the magnetic recording medium stamper according to the present invention is not limited to such and it is possible to manufacture the stamper S using various kinds of support substrate, such as a ceramic substrate and a metal substrate. In this case, when using a method of manufacturing that uses a support substrate formed of an insulating material (i.e., a ceramic substrate or the like) and forms a latent image 62b on a resist layer 62a by irradiating an electron beam EB, to prevent electrostatic charging from occurring when the electron beam EB is irradiated, the surface of the support substrate should preferably be made conductive.

In addition, although an example where the conductive film 63 is formed by the laminating device 35 depositing Ni (nickel) on the surface of the glass substrate 61 when manufacturing the stamper S is described in the above embodiment, the method of manufacturing a magnetic recording medium stamper according to the present invention is not limited to such and the conductive film 63 may be formed by an electroless plating process or sputtering. In addition although a method of manufacturing that specifies the center of the preform M based on the mark Mm is described in the above embodiment, the present invention is not limited to such and it is possible to specify the center by calculation after finding the coordinates of three arbitrary points on the outer edge of the preform M, for example.

### INDUSTRIAL APPLICABILITY

As described above, according to the method of manufacturing a magnetic recording medium according to the present invention, the center of a magnetic recording medium stamper specified based on a stamper center specifying mark formed on the stamper and the center of a magnetic recording medium preform are positioned so as to be aligned when viewed from the thickness direction of the magnetic recording medium preform and then a concave/convex pattern of the magnetic recording medium stamper is transferred to a resin layer. By doing so, compared for example to a method that specifies the center of the stamper by calculation after measuring the coordinates of three points on an arbitrary convex part in the concave/convex pattern of the magnetic recording medium stamper, it is possible to reliably and easily specify the center of the stamper in a short time. Accordingly, the magnetic recording medium stamper can be positioned in a short time relative to a magnetic recording medium manufacturing apparatus (imprinting apparatus). By doing so, a method of manufacturing a magnetic recording medium that can sufficiently improve the manufacturing efficiency of a discrete track medium is realized.

### BRIEF DESCRIPTION OF THE DRAWINGS

FIG. 1 is a block diagram showing the construction of a magnetic recording medium manufacturing apparatus 1 according to an embodiment of the present invention.

FIG. 2 is a cross-sectional view showing the construction of a discrete track medium D manufactured by the magnetic recording medium manufacturing apparatus 1.

FIG. 3 is a cross-sectional view showing the construction of a preform M according to the embodiment of the present invention.

FIG. 4 is a perspective view showing the appearance of the preform M.

FIG. 5 is a cross-sectional view showing the construction of a stamper S according to the embodiment of the present invention.

FIG. 6 is a perspective view showing the appearance of the stamper S.

FIG. 7 is a block diagram showing the construction of a preform manufacturing apparatus 2 according to the embodiment of the present invention.

FIG. 8 is a cross-sectional view of a disk-shaped glass substrate 51a molded by an injection molding device 21.

FIG. 9 is a cross-sectional view showing a state where a base layer 52, a soft magnetic layer 53, an oriented layer 54, and a recording layer 55 have been formed in that order on the glass substrate 51.

FIG. 10 is a cross-sectional view of a state where a protective layer 56 is formed on the recording layer 55.

FIG. 11 is a block diagram showing the construction of a stamper manufacturing apparatus 3 according to the embodiment of the present invention.

FIG. 12 is a cross-sectional view showing a state where a resist layer 62a has been formed on a glass substrate 61.

FIG. 13 is a cross-sectional view showing a state where the resist layer 62a has been developed to form a mask 62.

FIG. 14 is a cross-sectional view showing a state where the glass substrate 61 has been etched using the mask 62 to form concave parts 61a, 61a . . .

FIG. 15 is a cross-sectional view showing a state where a conductive film 63 has been formed on the glass substrate 61 in which the concave parts 61a, 61a . . . are formed.

FIG. 16 is a cross-sectional view showing a state where a metal film 64 has been formed on the conductive film 63.

FIG. 17 is a cross-sectional view showing a state where a multilayer structure (i.e., the stamper S) composed of the conductive film 63 and the metal film 64 has been withdrawn from the glass substrate 61.

FIG. 18 is a cross-sectional view showing a state where a resist has been applied on the preform M to form a resist layer 58a.

FIG. 19 is a cross-sectional view showing a state where the mark Mm of the preform M (the circular concave part 58m of the resist layer 58a) and a reference position P1 of the press base section 12a have been aligned and a state where a mark Sm of the stamper S and a reference position P2 of the press head section 12b have been aligned.

FIG. 20 is a cross-sectional view showing a state where convex parts of a concave/convex pattern of the stamper S have been pressed into the resist layer 58a on the preform M.

FIG. 21 is a cross-sectional view showing a state where the stamper S in the state shown in FIG. 20 has been withdrawn from the resist layer 58a.

FIG. 22 is a cross-sectional view showing a state where the mask 58 has been used to etch the preform M.

FIG. 23 is a cross-sectional view of a preform Mx according to another embodiment of the present invention.

FIG. 24 is a cross-sectional view of a stamper Sx according to another embodiment of the present invention.

FIG. 25 is a plan view of marks Mm1, Sm1 that are other examples of a preform center specifying mark and a stamper center specifying mark according to the present invention.

FIG. 26 is a plan view of marks Mm2, Sm2 that are further examples of a preform center specifying mark and stamper center specifying mark according to the present invention.

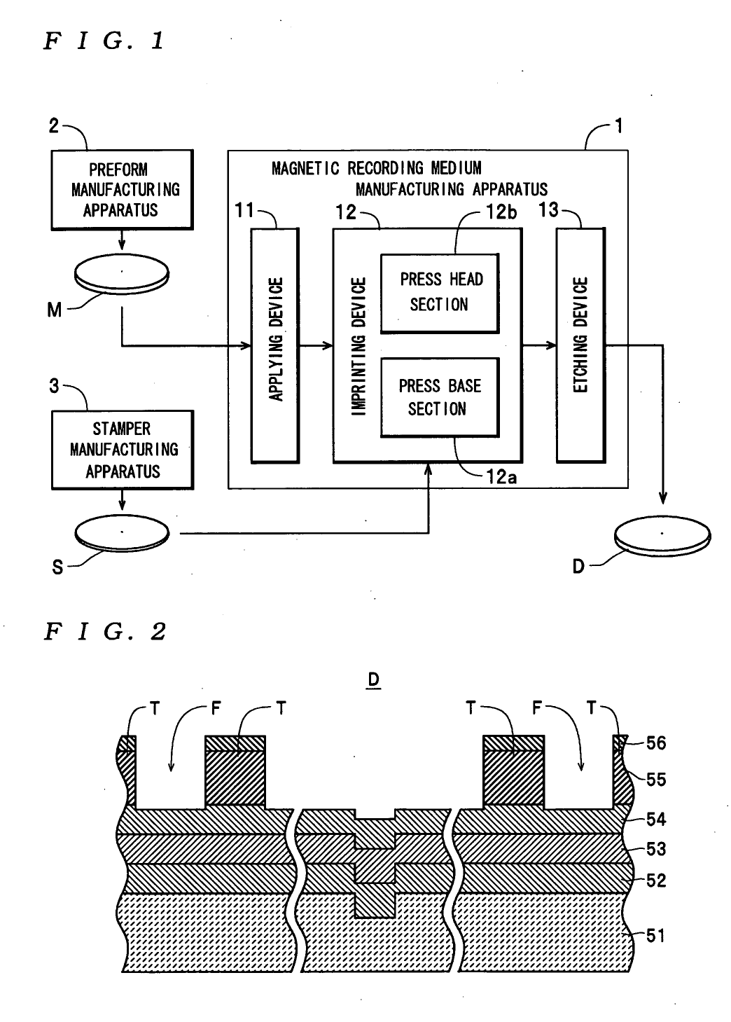

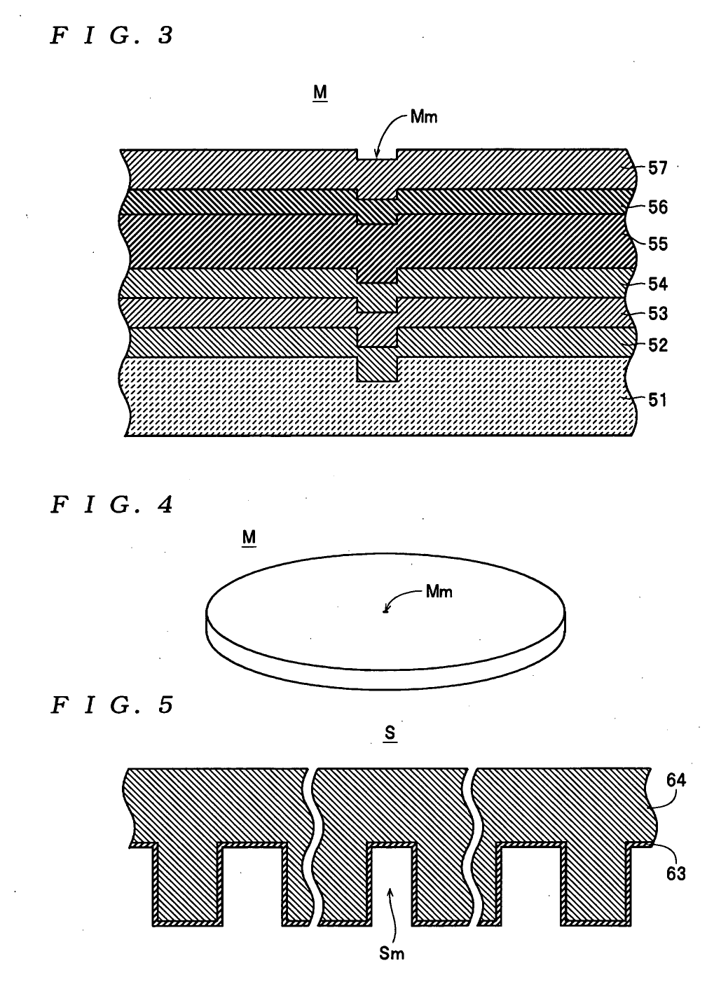

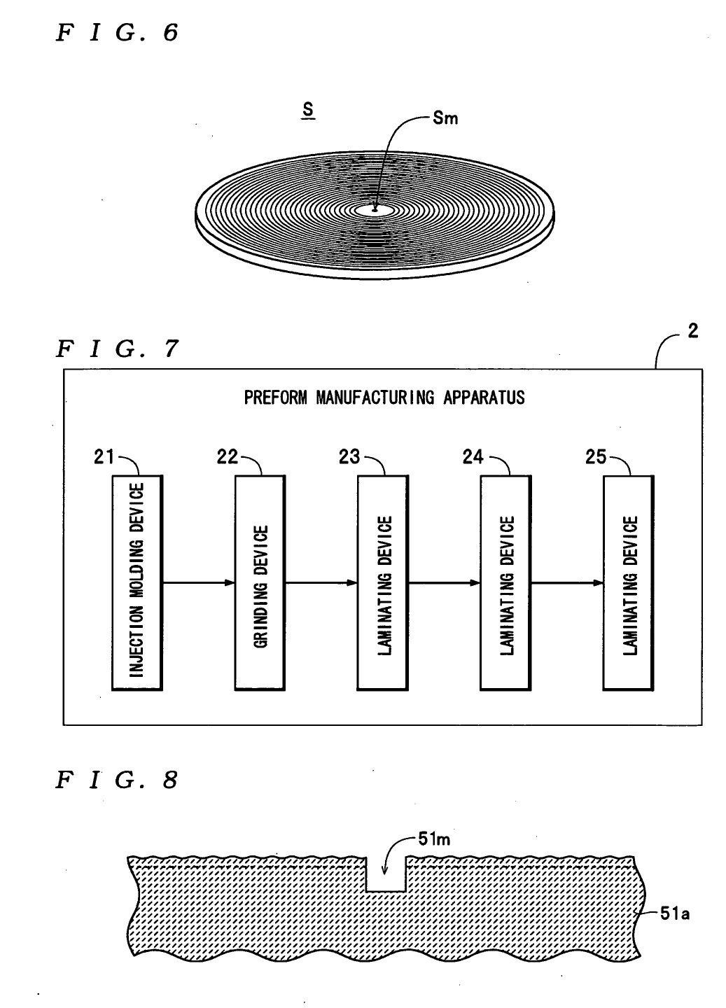

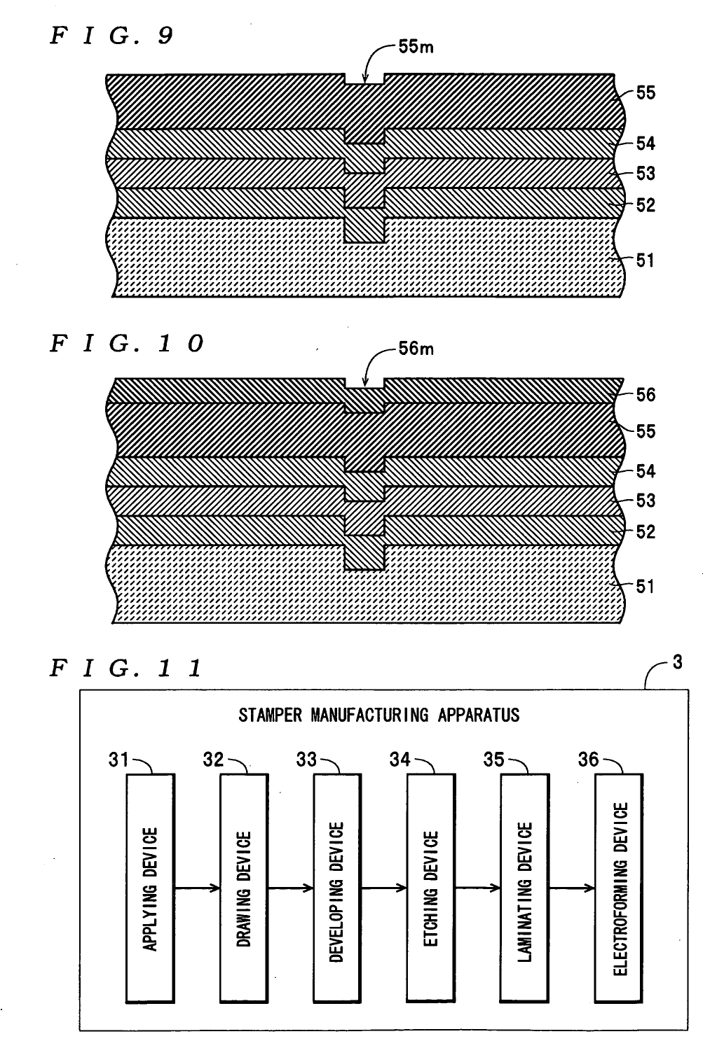

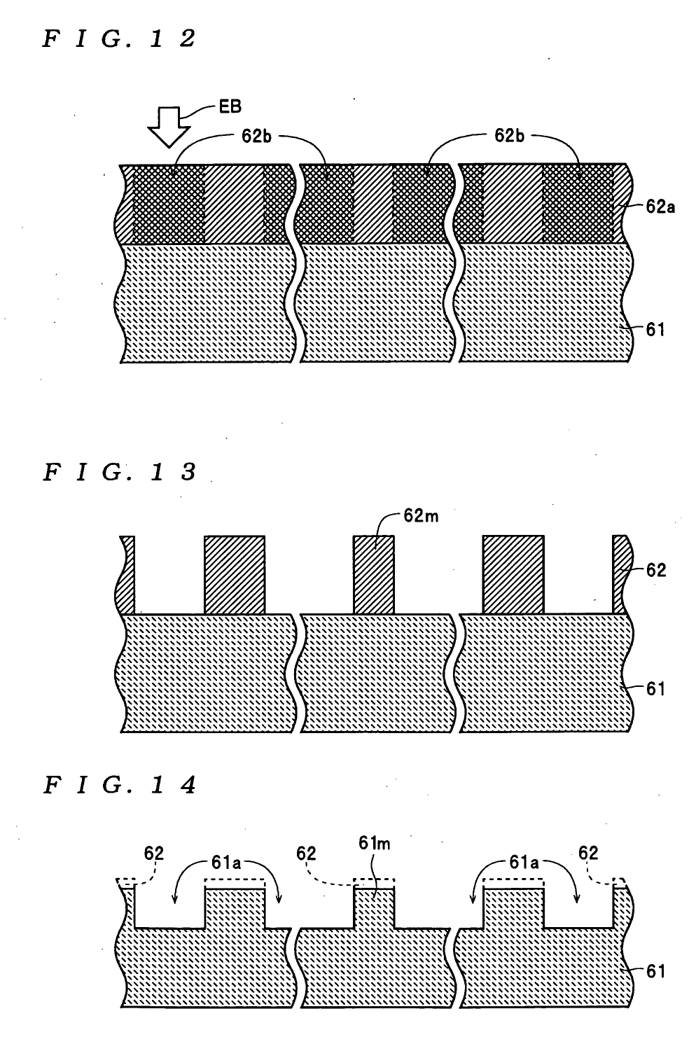

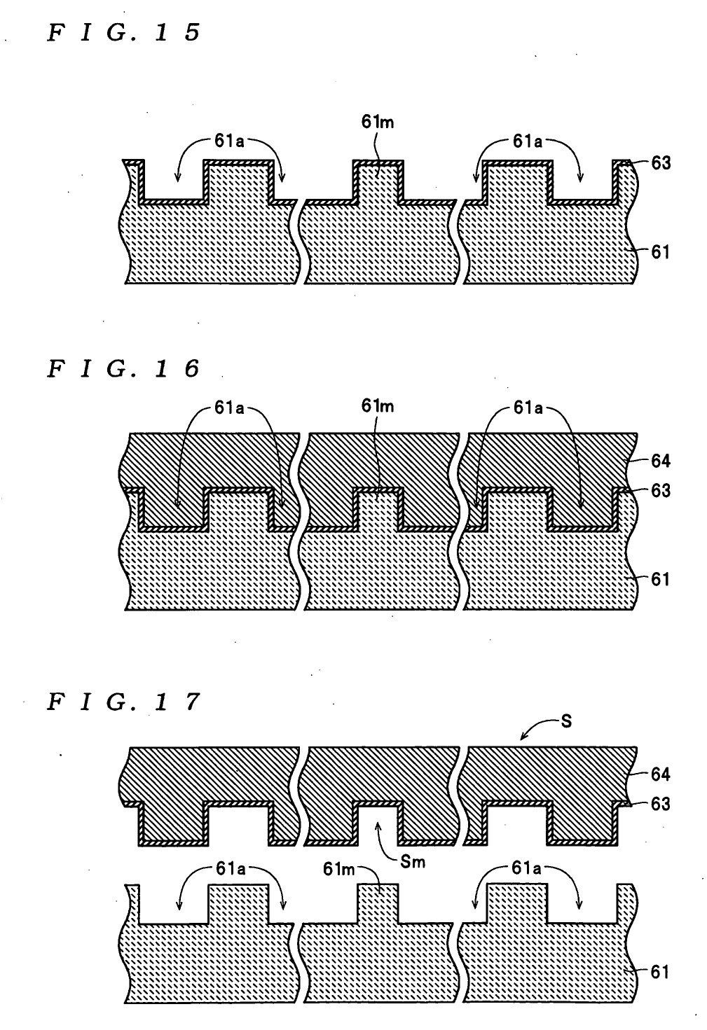

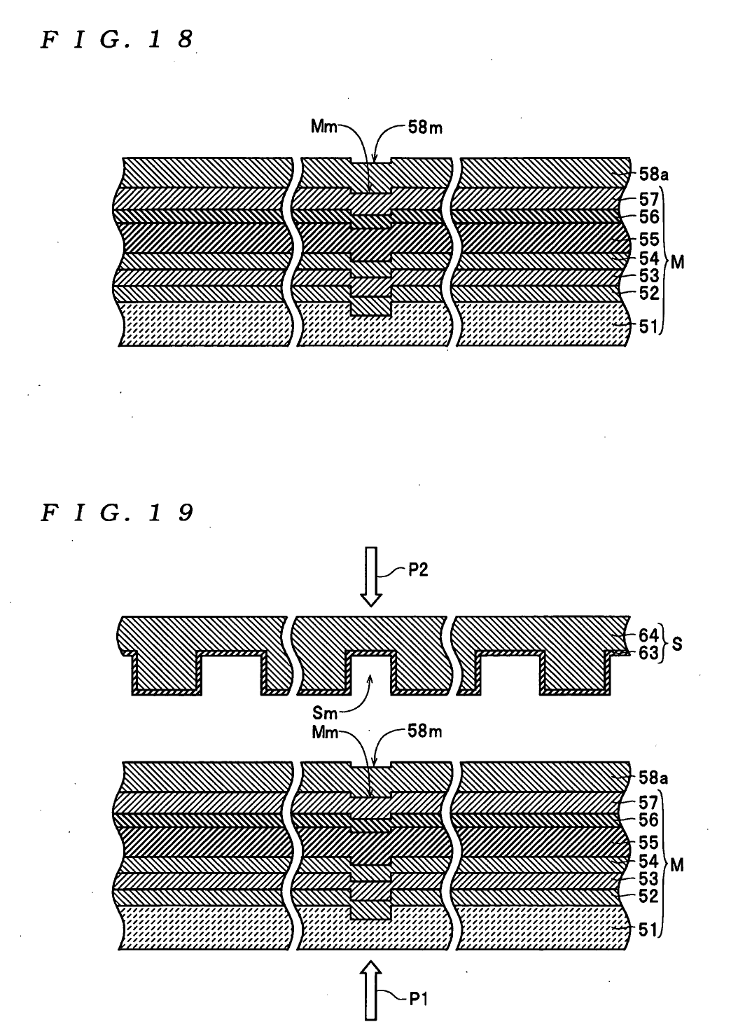

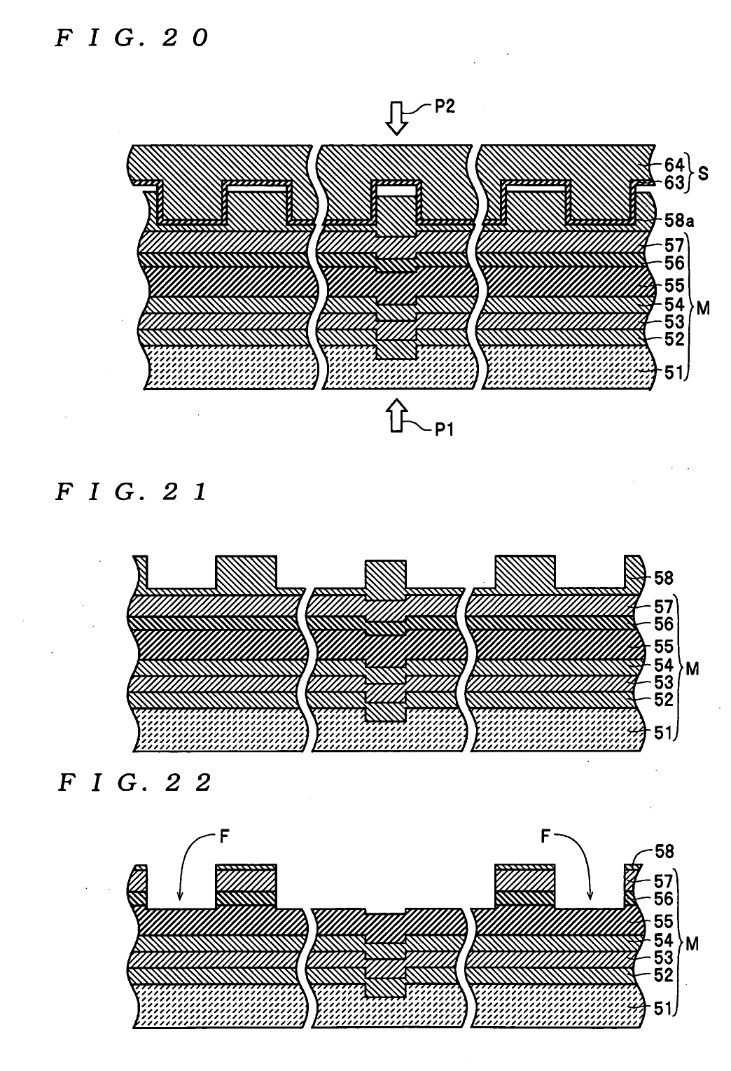

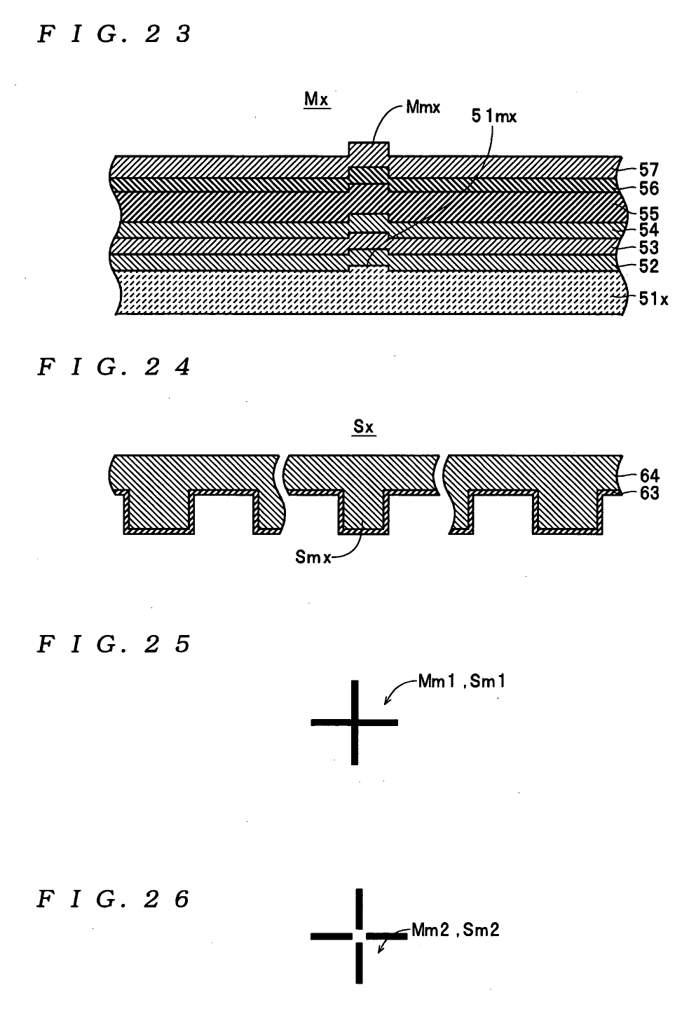

### DESCRIPTION OF REFERENCE NUMERALS

1. Magnetic recording medium manufacturing apparatus
2. Preform manufacturing apparatus
3. Stamper manufacturing apparatus
11. Applying device
12. Imprinting device
13. Etching device
51. Glass substrate
55. Recording layer
58. Mask
58a. Resist layer
D. Discrete track medium
M, Mx. Preform
Mm, Mmx, Mm1, Mm2, Sm, Smx, Sm1, Sm2. Mark
S, Sx. Stamper

1. A method of manufacturing a magnetic recording medium for manufacturing a discrete track magnetic recording medium comprising:
forming a resin layer on a magnetic recording medium preform in the shape of a flat plate where a magnetic layer is formed on a support substrate and specifying a preform center of the magnetic recording medium preform;
placing a magnetic recording medium stamper on the magnetic recording medium preform with the specified preform center and a stamper center specified based on a stamper center specifying mark formed on the magnetic recording medium stamper aligned when viewed from the thickness direction of the magnetic recording medium preform to transfer a concave/convex pattern of the magnetic recording medium stamper to the resin layer; and
forming concave parts in the magnetic layer of the magnetic recording medium preform using the resin layer to which the concave/convex pattern has been transferred.

2. A method of manufacturing a magnetic recording medium according to claim 1, wherein as the magnetic recording medium preform, a magnetic recording medium preform on which a preform center specifying mark that can specify the preform center is formed is used and the concave/convex pattern is transferred to the resin layer by placing the magnetic recording medium stamper on the magnetic recording medium preform with the preform center, which is specified based on the preform center specifying mark, and the stamper center aligned when viewed from the thickness direction.

3. A magnetic recording medium stamper where a concave/convex pattern for manufacturing a discrete track magnetic recording medium is formed and a stamper center specifying mark capable of specifying a center of the stamper is formed.

4. A magnetic recording medium stamper according to claim 3, wherein the stamper center specifying mark is constructed of one of a convex part where part of a central area of the magnetic recording medium stamper protrudes and a concave part where part of a central area of the magnetic recording medium stamper is depressed.

5. A magnetic recording medium preform wherein a magnetic layer is formed on a support substrate so as to be capable of manufacturing a discrete track magnetic recording medium and a preform center specifying mark capable of specifying a center of the magnetic recording medium preform is formed.

6. A magnetic recording medium preform according to claim 5, wherein the preform center specifying mark is constructed of one of a convex part where part of a central area of the magnetic recording medium preform protrudes and a concave part where part of a central area of the magnetic recording medium preform is depressed.
